(19) United States
(12) Patent Application Publication
(10) Pub. No.: US 2005/0186367 A1
(43) Pub. Date: Aug. 25, 2005

(54) Low friction, abrasion-resistant materials and articles made therefrom

(76) Inventor: James R. Hanrahan, Newark, DE (US)

Correspondence Address: GORE ENTERPRISE HOLDINGS, INC., 551 PAPER MILL ROAD, P. O. BOX 9206, NEWARK, DE, 19714-9206, US

(21) Appl. No.: 10/783,399

(22) Filed: Feb. 19, 2004

(51) Int. Cl. B32B 3/26

(52) U.S. Cl. 428/34.1; 428/304.4; 428/292.1

(57) ABSTRACT

A friction-reducing abrasion resistant material is described. The material comprises an expanded polytetrafluoroethylene (ePTFE) film having dispersed therein a polymer resin material. This invention relates to such PTFE materials having a unique and useful combination of high strength and unique microstructure, which have been imbibed with thermoset or thermoplastic polymers. Articles made from these materials are particularly suitable for use as bearings such as mechanical plain bearing liner materials.

### BACKGROUND OF THE INVENTION

1. Field of the Invention

This invention relates to improved materials comprising expanded PTFE which are useful in bearing and other friction-reducing, abrasion resistant applications. These materials are suitable for a variety of applications in, for example, the aerospace, industrial, medical and agricultural industries.

2. Description of Prior Art

It is known in the art to utilize self-lubricating bearings and materials to provide reduced friction and reduced wear in a range of load-bearing applications. These bearings are expected to withstand damage during use and installation. Further, the self-lubricating bearings are typically subject during use to a variety of conditions such as heat and pressure, as well as chemical attack from a variety of substances.

The choice of a bearing material to meet a given need depends on the specific conditions and performance required and tends to be a complex engineering task in view of the many parameters which must be taken into account. A representative list of conditions that are to be taken into account might include, for example, velocity, pressure (including amount of load, direction of load, and speed of impact of load), dynamic friction, static friction, temperature, chemical exposure, lubrication, dimensional stability, geometrical fit, nature of the counter surface, and susceptibility to fluid lubrication erosion (“cavitation”).

Conventional friction management materials and systems include roller bearings, ball bearings, and plain bearings. In the plain bearing arena, many different forms of plastics bearing materials comprising a plastic matrix having various fillers and/or porous bonding layers are known. Many of them include polytetrafluoroethylene (PTFE), which is widely known for its low coefficient of friction. PTFE also provides the benefit of being stable under a wide range of temperatures and is inert to most chemicals. However, the wear characteristics, excessive creep and the bond strength to substrates of PTFE are poor, so different supporting materials are incorporated with the PTFE in various ways. Some of these supporting materials include metals, which are believed to draw heat away from the system and thus result in improved wear. In addition, some metals, such as lead, are thought to contribute to the lubricity of the system. However, the science of mechanisms in these systems is not fully understood.

Many products have been made available in this field, and a variety of patents exist, directed to bearing and other friction-reducing materials incorporating polytetrafluoroethylene (PTFE). For example, many bearing materials incorporate PTFE floc, or short fibers, which are incorporated into a resin material and spray coated onto a substrate. U.S. Pat. No. 3,806,216 describes materials which are representative of this type of construction. In another form, PTFE film has been skived from a solid, full-density PTFE block, then laminated to fabric or metal backers and bonded together with various resin systems. U.S. Pat. No. 4,238,137, to Furchak, describes materials which are representative of this type of construction. PTFE fibers formed into woven or non-woven sheets or fabrics, which are then impregnated with resin (e.g., U.S. Pat. No. 4,074,512) and/or laminated to an epoxy or other backing material (e.g., U.S. Pat. No. 3,950,599) have also been used as bearing materials. PTFE floc or particles have been incorporated into a thermoplastic material, then molded and/or machined into bearings. Further, PTFE dispersions, sometimes combined with fillers, have been dried or otherwise bonded on a sintered metal layer/metal substrate or other metal substrate (e.g., U.S. Pat. Nos. 2,689,380; 5,498,654 and 6,548,188 and Japanese Unexamined (Kokai) Patent Application No. 3-121135).

U.S. Pat. No. 5,792,525 to Fuhr et al., teaches bearing parts formed from one or more layers of a densified expanded PTFE material which can be machined or otherwise formed to the desired shape. Such materials exhibit good resistance to creep under a load; however, the wear limitations of such materials limit their use in many demanding bearing applications.

As can be seen from the wide range of PTFE-containing materials described, some solution has been developed for virtually every bearing application; however, the market continues to need lower friction, lower wear systems that enable lower power consumption and longer bearing life. In addition, environmental concerns regarding lead have resulted in a search for lead-free materials that perform as well as, or better than, the current lead-containing materials.

Accordingly, a need has existed in the field of self-lubricated bearing materials and bearing articles for a new material exhibiting enhanced wear resistance and low friction relative to conventionally available materials.

### SUMMARY OF THE INVENTION

This invention is a unique wear resistant composite material that solves many of the current problems of the self lubricated bearings market. The composite combines a particular expanded polytetrafluoroethylene (or ePTFE) with other polymer materials in a unique configuration which has heretofore not been achieved in the art.

Expanded PTFE is characterized by a structure of nodes interconnected by fibrils, and the appearance of this node and fibril structure can vary depending on whether the material is expanded in one direction (e.g., uni-axial) or in multiple directions (e.g., bi-axial, multi-axial, etc.). Expanded PTFE exhibits all of the beneficial properties of PTFE described earlier herein, while providing the further benefits of high porosity and high strength.

It has been surprisingly discovered that ePTFE materials which exhibit or possess a particular node and fibril structure, whether in the form of membranes, rods, tubes or other suitable forms, can be imbibed with wear-resistant polymer resins comprising thermosetting resins or thermoplastic resins, such as described in more detail herein, to yield unique low friction, wear resistant materials. Bearing materials made from the resulting imbibed structures exhibit improved wear resistance when compared to conventional self-lubricating bearing materials available in the prior art. The preferred imbibed structures of the present invention incorporate coarse, highly porous ePTFE structures which are strong and have microstructures of relatively large nodes interconnected by relatively long fibrils. These resulting structures are particularly useful in bearing and other friction-reducing, abrasion-resistant applications. As noted, a key feature of this invention is the combination of these particular unique ePTFE structures with one or more polymer resins, as described in more detail herein.

The preferred ePTFE structures of this invention can be described more particularly as exhibiting a columnar nodal microstructure, whereby on visual inspection of a cross-sectional microstructure one can identify one or more columns of aligned nodes in the thickness direction of the material (i.e., in the direction orthogonal to the plane of the fibrils). More preferred ePTFE structures exhibit one or more columns of aligned nodes through a substantial portion (e.g., 50% or more) of the thickness. Depending on the particular ePTFE material, the microstructure may include columns comprising a plurality of nodes, columns comprising s single node, or some combination thereof. Referring to FIG. 4, for example, showing the node 21 and fibril 23 structure of a unique ePTFE materials suitable in this invention, the nodes 21 exhibit a stacked, or columnar, alignment through at least a portion of the thickness of the ePTFE material. The imbibed and cured cross-sectional microstructure shown in FIG. 5, while visually different from the unimbibed structure, also shows a degree of columnar alignment of the nodes 21.

Polymer resin materials suitable for imbibing into the ePTFE structures of the present invention can include a wide range of thermosetting resins including, but not limited to, epoxies and their hybrids, phenolics, polyesters, acrylates, polyimides, polyurethanes, cyanate esters, bismaleimide, polybenimidazole, and the like. The preferred thermosetting resins are those which have high thermal stability (e.g., epoxies, polyamide-imide, cyanate esters and phenolic resins, etc.). In addition, many thermoplastic resins including, but not limited to, polyetheretherketone (PEEK), polyetherketone (PEK), polyaryletherketone (PAEK), liquid crystal polymer (LCP), polyimide (PI), polyetherimide (PEI), acetals, acrylics, fluoropolymers, polyamides, polycarbonates, polyolefins, polyphenylene oxides, polyesters, polystyrenes, polysulfones, polyethersulfones, polyphenylene sulfide, polyvinyl chloride, and the like, may also be imbibed into the ePTFE structures to form low friction, wear-resistant composites.

Depending on the desired application and performance of the resulting composite material, the volume ratio of solids (PTFE to polymer resin) may vary significantly. Materials with resin volume percents ranging from 22% to 74% have resulted in suitable composites in accordance with the present invention; however, higher volume percents and lower volume percents are also contemplated to be within the scope of suitable composites for the low friction, abrasion-resistant materials of this invention.

Depending on the particular performance desired, the imbibed ePTFE composite materials may also incorporate one or more fillers to alter or tailor the performance to meet a specific performance requirement. For example, a filler such as graphite or boron nitride may be included to lower the composite coefficient of friction (COF). Further, fillers such as aluminum oxide, titanium dioxide, glass fiber, or carbon may be used to improve wear resistance, even if such fillers might tend to increase the COF.

The unique materials of the present invention may optionally be further shaped and/or bonded to a variety of substrates, as discussed in more detail herein, to achieve unique low friction, load-bearing articles.

### DESCRIPTION OF THE DRAWINGS

The foregoing summary, as well as the following detailed description of the invention, will be better understood when read in conjunction with the appended drawings. For purposes of illustrating the invention, there are shown in the drawings embodiments which are presently preferred. It should be understood, however, that the invention is not limited to the precise arrangements and instrumentalities shown. In the drawings:

FIGS. 1 and 2 are schematic representations of the rotating test specimen and the test fixture, respectively, for performing wear testing on the materials of the invention;

FIG. 3 is a graph of the load vs. compression for the test fixture shown in FIG. 1 during wear testing.

FIG. 4 is a cross-sectional perspective photomicrograph at 250× magnification of the expanded PTFE membrane of Example 1 prior to imbibing with the epoxy.

FIG. 5 is a cross-sectional perspective photomicrograph at 300× magnification of the expanded PTFE membrane of Example 1 after imbibing and curing the epoxy.

FIG. 6 is a graph showing the Coefficient of Friction vs. Number of Laps for the material of Example 1.

FIG. 7 is a cross-sectional perspective photomicrograph at 250× magnification of the expanded PTFE membrane of Example 3 prior to imbibing with the epoxy.

FIG. 8 is a cross-sectional perspective photomicrograph at 300× magnification of the expanded PTFE membrane of Example 3 after imbibing and curing the epoxy.

FIG. 9 is a cross-sectional perspective photomicrograph at 250× magnification of the expanded PTFE membrane of Example 9 prior to imbibing with the epoxy.

FIG. 10 is a cross-sectional perspective photomicrograph at 300× magnification of the expanded PTFE membrane of Example 9 after imbibing and curing the epoxy.

FIGS. 11, 12, 13 and 14 are cross-sectional perspective photomicrographs of the materials of Comparative Examples 1, 2, 3 and 4, respectively.

FIG. 15 is a graph showing the Coefficient of Friction vs. Number of Laps for the material of Comparative Example 1.

### DETAILED DESCRIPTION OF PREFERRED EMBODIMENTS

In the current invention, a composite material is made with a coefficient of friction (COF) similar to pure PTFE, but with a significantly lower wear rate. This is achieved by imbibing wear resistant polymer resin materials within specific ePTFE structures.

In order to create such a composite, it is important to start with a particular expanded PTFE, or ePTFE, structure. The concept of a node and fibril structure, as related to an ePTFE article, was first introduced in U.S. Pat. No. 3,953,566, to Gore. Expanded PTFE materials have since been made exhibiting different microstructures and a wide variety of forms, such as rods, tubes, membranes, and the like, with either single or multiple layers. I have surprisingly found that there are preferred ePTFE structures that yield the most wear resistant composites when incorporated in the unique materials of this invention.

For example, I have found that an ePTFE structure as produced in accordance with U.S. Pat. No. 4,482,516, to Bowman et al., is a preferred article for creating the unique composites of the present invention which are particularly useful for bearings and other low friction, wear resistant applications. In the Bowman et al. patent, which is specifically incorporated herein by reference, the inventors teach how to make coarse, highly porous articles of ePTFE that are strong and have large nodes. These structures typically have a large pore size, and, as mentioned earlier, a high strength. The microstructure also exhibits a columnar, or stacked, alignment of the nodes in at least a portion of the thickness direction of the material. Such a material is taught by Bowman et al. to be particularly useful in the biological field.

I have surprisingly found that these and similar ePTFE structures also have utility as wear resistant materials when at least a portion of the porosity is filled with at least one wear resistant polymer, as described herein. This unique blend of materials provides for excellent wear resistance, while maintaining a low coefficient of friction. These and other comparable structures will be explored further in the practical examples.

As described earlier, polymer materials suitable for imbibing into the ePTFE structures can include a wide range of thermosetting and thermoplastic polymer resins, particularly those exhibiting wear resistance. The term “wear-resistant polymer resins,” as used herein, is intended to refer to polymer resins have a modulus equal to or greater than the modulus of PTFE (about 0.7 GPa), more preferably a modulus of at least 1.5 GPa, and most preferably a modulus of at least 2 GPa. Suitable thermosetting resins including, but not limited to, epoxies and their hybrids, phenolics, polyesters, acrylates, polyimides, polyurethanes, cyanate esters, bismaleimide, polybenimidazole, and the like. The preferred thermosetting resins are those which have high thermal stability (e.g., epoxies, polyamide-imide, cyanate esters and phenolic resins, etc.). In addition, many thermoplastic resins including, but not limited to, polyetheretherketone (PEEK), polyetherketone (PEK), polyaryletherketone (PAEK), liquid crystal polymer (LCP), polyimide (PI), polyetherimide (PEI), acetals, acrylics, fluoropolymers, polyamides, polycarbonates, polyolefins, polyphenylene oxides, polyesters, polystyrenes, polysulfones, polyethersulfones, polyphenylene sulfide, polyvinyl chloride, and the like, may also be imbibed into the ePTFE structures to form low friction, high wear composites.

While the thermosetting or thermoplastic polymer resin(s) enhance the wear resistance of the resulting articles, the selection of the polymer resin is also important for the success of the composite for a number of other reasons, and the particular resin selection may vary depending on the requirements of a given application. For a typical industrial bearing application, the imbibed resin also provides the following beneficial features: completely or partially fills the voids in PTFE, provides bonding capability to other substrates, reduces or prevents deformation under load (i.e. creep resistance), and provides dimensional rigidity. I have found in certain preferred embodiments that the material that best balances all of these properties is an epoxy resin comprising a combination of an epoxy, a curing agent and an additive, i.e., curing accelerator. In a particularly preferred embodiment, the epoxy can be any of bisphenol A, bisphenol F, epoxy cresol novolac, epoxy phenol novolac, and many other commercially available epoxy materials. The curing agent can be, but is not limited to, aliphatic amines, aromatic amines, amidoamines, polyamides, amine complexes, dicyandiamide, urea, imidazoles, polyphenols, anhydrides and acids. However, it is important to note that epoxies may not be the material of choice for every application. For example, if an application required extremely high temperature resistance (450° F.), a polyimide would be better suited for a preferred embodiment. Again, depending on the desired end use, the choice of polymer resin or resins will vary.

In order to incorporate the thermosetting or thermoplastic polymers into the unique ePTFE structures of the invention, the polymers can be put into liquid form by melting or solvating. One preferred method for forming these types of composites is to imbibe a solvated polymer into at least a portion of the void space of the ePTFE structure. This method allows for easy control of the polymer loading, as well as simple processing to achieve the final result. In such a process, all ingredients in thermosetting or thermoplastic resins are dissolved in solvent(s). Solvent(s) not only dissolve the ingredients but also function as a wetting agent to wet the ePTFE material. The ePTFE material is imbibed with this blend. There are a variety of processes for imbibing an ePTFE structure, such as dip coating, kiss-roll coating, spray coating, brush coating, vacuum coating, and comparable techniques apparent to one of skill in the art. The solvent(s) is removed after imbibing to leave all solid ingredients in the voids of the ePTFE material.

The imbibed ePTFE composite material, sometimes referred to as a “pre-preg,” can then be put into a form for use as a bearing article. This can be done in one preferred embodiment by bonding the “pre-preg” to a backing or substrate material. Such a backing material can be made of metal, a themosetting material or other suitable substrate to which the pre-preg can bond. For example, a steel sheet and an epoxy mold are two representative forms of suitable substrate. In a preferred embodiment comprising bonding to a steel substrate, the pre-preg can be bonded to the substrate by the following steps: a steel plate substrate is cleaned with methyl ethyl ketone (MEK); the epoxy resin/ePTFE “pre-preg” is put on the steel plate and a release film is placed on the pre-preg side opposite the steel plate. A metal sheet is placed on top of the release sheet. The assembly is put on a Carver press unit and subjected to a compressive load between 40 and 1000 psi, at a temperature of 160-200° C. for a thirty minute duration. During this heating and compressing step, the imbibed epoxy resin flows in the ePTFE structure and is distributed in the porosity, cures (i.e. becomes cross-linked) and bonds to the steel, resulting in a substantially pore-free structure bonded to the steel substrate. The result is a bearing article which has a low friction surface, a tenacious bond between the composite material and the substrate and excellent wear resistance. This article may be used as formed, or alternatively, may be cut, stamped, curled, flanged or otherwise formed into a desired geometry.

In an alternative preferred embodiment for forming a bearing of this invention, rather than bonding to a substrate, the “pre-preg” may be simply cured between release layers in the manner described above, then the resulting article may be used as formed (e.g., in sheet, tube, etc., geometry) or may be further cut (e.g., washers or the like), stamped, curled, flanged, etc., to provide a form suited to a particular bearing application.

A further alternative preferred embodiment for forming a bearing material of this invention is to first cure the “pre-preg” between release layers as described above, then subsequently laminate a pressure sensitive adhesive to this composite layer, either with or without the further forming techniques noted above, thus providing a “peel and stick” bearing article, that can be applied to any substrate surface at any time.

The resulting bearing materials of this invention may be used in a variety of industrial, aerospace, medical, agricultural and other applications where the advantageous features of low-friction, or lubriciousness, and wear-resistant load bearing are desirable. Exemplary articles contemplated may include, but clearly are not limited to, bearings, washers, clutches, tensioning devices, wear-resistant surfaces, and the like, in the form of three-dimensional articles, coatings, surfaces, etc.

Bearing material samples in the present invention were prepared according to the procedure described above for bonding to a steel plate, then they were tested for their resistance to wear based upon the wear tests described below.

### Test Methods

Wear Test

Apparatus:

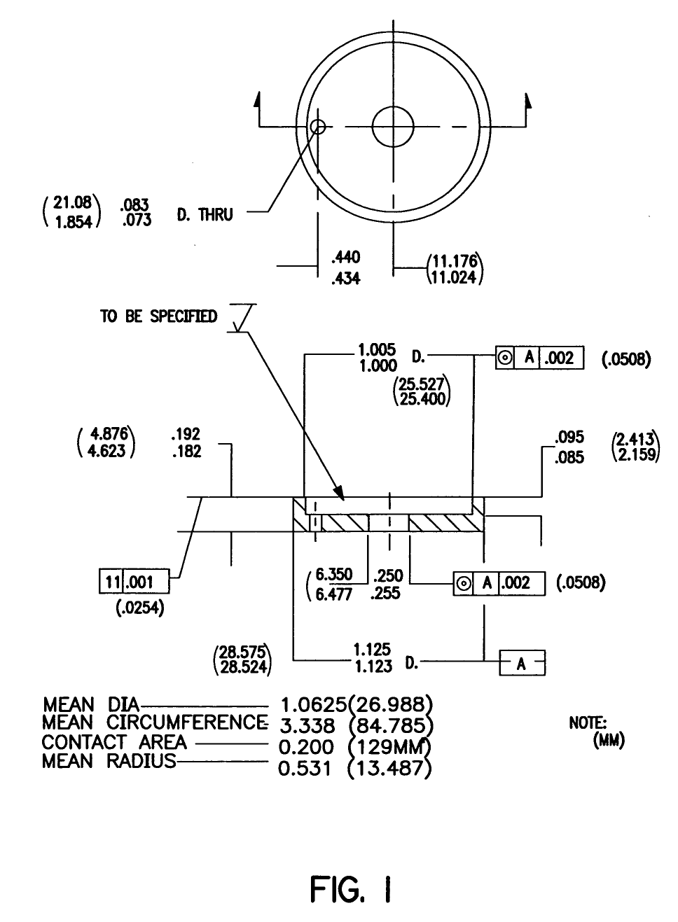

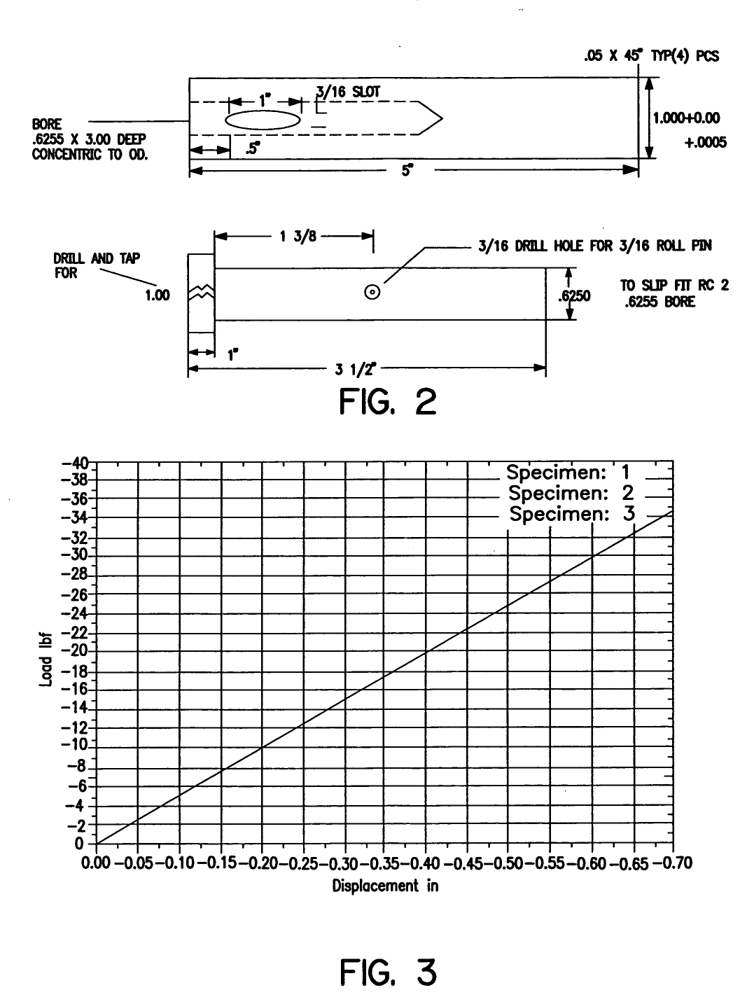

A testing device was made substantially in accordance with ASTM D 3702. The apparatus is designed to test the wear rate of self-lubricating materials and utilizes a thrust washer specimen configuration. The test machine is operated with a stationary test sample, and a steel rotating test specimen against the sample, under load. All samples were tested at a load of 26 pounds (130 psi) and a velocity of 540 rpm (150 fpm). In order to apply the correct load and speed, a fixture was designed to fit in a Bridgeport milling machine Model J Head Series II. The fixture was spring loaded so that, when compressed to the appropriate distance, it applied a 26 pound load. The milling machine was able to control the amount of compression and the speed at which the fixture operated. See FIGS. 1 and 2 for a schematic drawings of the rotating test specimen and the test fixture, respectively.

Rotating Test Specimen:

The rotating test specimen was made of 1018 stainless steel, with a finish of 8-12 μ-inch. A diagram of the specimen is shown below. The specimen was exactly copied from the ASTM D 3702 test and is shown schematically in FIG. 1.

Test Fixture:

The test fixture was designed to hold the rotating test specimen and apply a constant load. A schematic drawing of the fixture is shown in FIG. 2.

After the fixture was assembled, it was placed on an INSTRON® Universal Material Test Machine Model No. 5567, (Instron Corporation, Canton, Mass.) to determine the amount of compression required for 26 pounds of load. FIG. 3 is a graph of the load vs. compression for the fixture.

Test Procedure:

Each sample was tested in the following manner. First, the fixture was mounted in the milling machine and aligned perpendicularly to the base upon which the sample was mounted. This was done to ensure the rotating test specimen would be level on the test sample. Next, the test sample and rotating specimen were cleaned with isopropyl alcohol to eliminate any oils from the system. The test sample was then mounted to the base of the milling machine. Each time a sample was tested a new rotating specimen was mounted to the fixture. Before the test was started, the milling machine was turned on and set to 540 rpm, using a tachometer. The machine was then stopped and the test sample was brought into contact with the rotating specimen.

A 0.001 inch thick metal shim was placed on the test sample, then the fixture was lowered until it just engaged the shim. The shim was then removed, and the base of the milling machine was raised to compress the spring the correct amount (0.550 inch). The milling machine was then turned on, and the wear test was started. The test was run for the desired time, as noted in the examples.

After the test, the sample was removed and examined for the amount of wear that had occurred. An optical interferometer was used to measure the wear “scar”. The sample was measured in four locations, and an average scar depth and width were determined. Wear “scars” were measured using a Zygo New View 5000 Scanning White Light Interferometer (Lambda Photometrics, Hertfordshire, UK). Results were obtained using a 5× objective (2.72 micron laternal resolution) and 0.5× zoom (4.53 micron camera resolution) with an appropriate bipolar (up to 145 microns) or extended (up to 500 microns) scan. Z-axis resolution was better than 1 μm. Stage tilt and pitch were adjusted to make surfaces outside the wear scar parallel to the optics before data collection.

Scar depths were quantified using histograms. Because images were carefully flattened with respect to the optics, the highest part of the image was the surface outside the groove. Date from this image produced the peak with the largest x-axis value in the histogram. This value was taken as the average position of the sample outside the scar. The scar bottom produced a second peak at lower x-axis in the histogram. The distance between the peaks measured from the scar and the area outside the scar was defined as the scar depth.

Coefficient of Friction Test

Coefficient of friction testing was carried out at Micro Photonics Inc., located in Irvine, Calif. The test apparatus used was a pin-on-disk tribometer and the test was run in accordance with ASTM G 99-95a. Results are reported as mean Coefficient of Friction.

### EXAMPLES

### Example 1

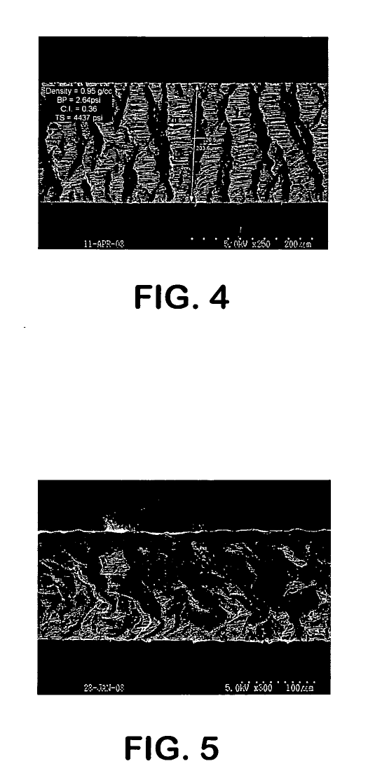

An ePTFE material sample measuring 8 inches by 8 inches with a thickness of 0.008 inch was obtained (W. L. Gore and Associates, Inc.) having a microstructure as shown in FIG. 4 and the following properties: density=0.95 g/cc, ethanol bubble point=2.64 psi, and tensile strength=4437 psi.

The sample was imbibed in the following manner. An epoxy resin composition was formulated with a blend of 56.4% EPON™ SU-3 (Resolution Performance Products), 18.8% EPON™ SU-8 and 24.8% ARADUR® 976-1 (Huntsman Advanced Materials, Basel, Switzerland). The epoxy blend was solvated to a 30% solid solution using MEK as a solvent. The material sample was placed on a 6″ diameter wooden hoop and restrained. The sample was first wetted with 100% MEK solution. The epoxy solution was then applied to the ePTFE sample by using a foam brush. The MEK was evaporated and subsequent epoxy solution coatings were applied until the microstructure was filled to a level of 30% by weight (44 volume percent of solids) of epoxy to PTFE. To be specific, the composition of 100 g of the composite would consist of 30 g epoxy and 70 g PTFE. The hoop was then put into a 65° C. oven for 10-15 minutes to remove the MEK completely. The sample was then in the “pre-preg” form. The “pre-preg” was removed from the hoop, trimmed and bonded to a carbon steel plate measuring 6 inch by 6 inch by 0.0625 inch thick. The bonding was done as previously described. The sample was then tested for wear resistance, and the results are reported in Table 1. FIG. 5 shows the cross section of the structure of FIG. 4 (unimbibed) after imbibing and curing.

An additional sample of material was then prepared according to the procedure described in this example, and the sample was tested over a 6 day period for wear resistance. Test results are also reported in Table 1. This test shows the stability of the wear resistance over time.

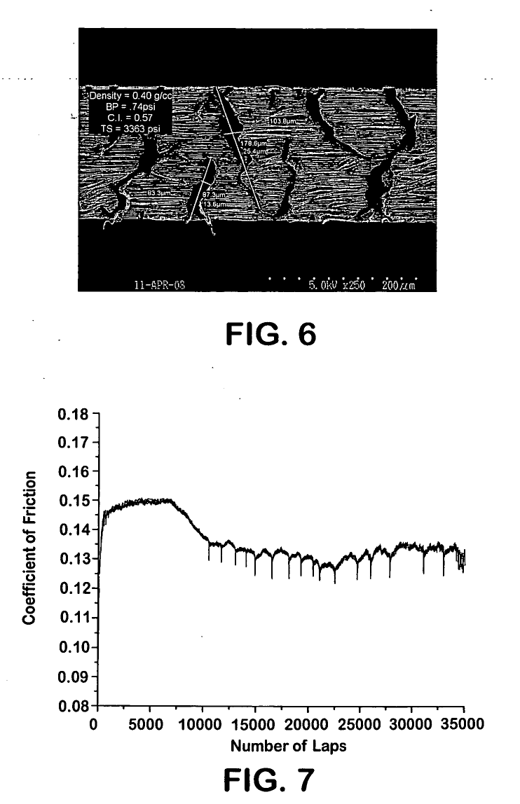

Coefficient of friction (COF) of the material of this example was also determined by subjecting a sample to the Coefficient of Friction Test, described above. A sample of the composite material made in this Example was bonded to a 1⅝ inch diameter piece of carbon steel, using the bonding technique previously described herein. The steel sample was ¼″ thick, and had been ground flat with a grinding wheel. The sample was then mounted to the pin-on-disc apparatus and tested at the following conditions:
Load: 3.5N
Speed: 105 cm/s
Radius: 17 mm
Ambient Temperature: 23C
Pin type: Ball
Ball Diameter: 6 mm
Ball Material: Steel 440C
#of Laps: 35,000
   The graph shown in FIG. 6 shows the COF as a function of the number of laps. The mean COF was 0.136

### Example 2

Another composite sample was made using the same ePTFE material and epoxy described in Example 1, except that the ePTFE material was imbibed to an epoxy level of 15% by weight (24.5 volume percent of solids). The sample was bonded to a carbon steel plate as in Example 1 and tested for wear resistance. Results are reported in Table 1.

### Example 3

An ePTFE material sample measuring 8 inches by 8 inches with a thickness of 0.0072 inch was obtained (W. L. Gore and Associates, Inc.) having large nodes and large inter-nodal distances with a high degree of uniformity, and with a columnar nodal microstructure as shown in FIG. 7 and the following properties: density=0.40 g/cc, ethanol bubble point=0.74 psi, and tensile strength=3363 psi.

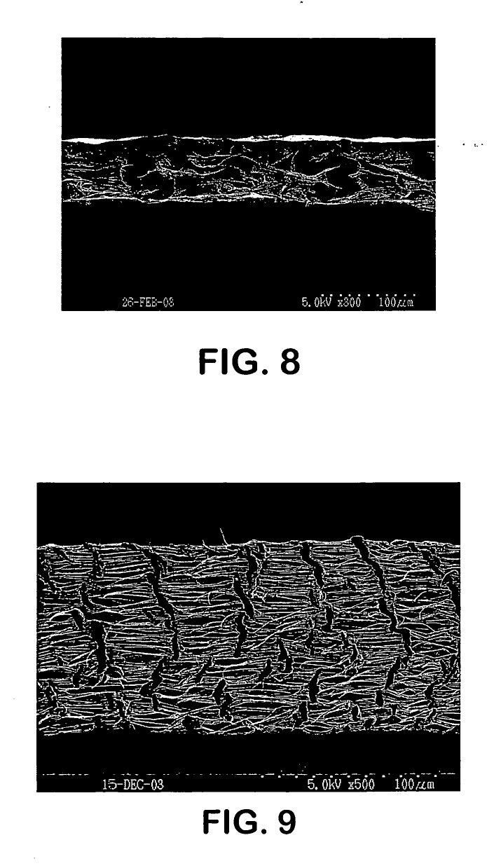

A sample of the tape was mounted on a 6″ diameter hoop, and imbibed as in Example 1, to a level of 30% by weight (44% by volume). The same epoxy resin used in Example 1 was used. The resulting composite was then bonded to a 6 inch by 6 inch by 0.0625 inch thick carbon steel plate, and tested for wear resistance. Results are reported in Table 1. FIG. 8 shows the cross sections of the structure of FIG. 7 (unimbibed) after imbibing and curing.

### Example 4

Another composite sample was made using the same ePTFE material described in Example 3 and the same epoxy and imbibing technique described in Example 1, except that the ePTFE material was imbibed to an epoxy level of 44% by weight (59% by volume). The resulting composite was then bonded to a 6 inch by 6 inch by 0.0625 inch thick carbon steel plate, and tested for wear resistance. Results are reported in Table 1.

### Example 5

Another composite sample was made using the same ePTFE material described in Example 3 and the same epoxy and imbibing technique described in Example 1, except that the ePTFE material was imbibed to an epoxy level of 61% by weight (74.1% by volume). The resulting composite was then bonded to a 6 inch by 6 inch by 0.0625 inch thick carbon steel plate, and tested for wear resistance. Results are reported in Table 1.

### Example 6

Another composite sample was made using the same ePTFE material described in Example 3 and the same epoxy and imbibing technique described in Example 1, except that the ePTFE material was imbibed to an epoxy level of 13.5% by weight (22.3% by volume). The resulting composite was then bonded to a 6 inch by 6 inch by 0.0625 inch thick carbon steel plate, and tested for wear resistance. Results are reported in Table 1.

### Example 7

Another composite sample was made using the same ePTFE material described in Example 3 and the same epoxy and imbibing technique described in Example 1, except that the ePTFE material was imbibed to an epoxy level of 22% by weight (34% by volume). The resulting composite was then bonded to a 6 inch by 6 inch by 0.0625 inch thick carbon steel plate, and tested for wear resistance. Results are reported in Table 1.

### Example 8

Another composite sample was made using the same ePTFE material described in Example 3, but the sample was imbibed with a polyimide resin in the manner described below.

Polyimide resin grade Kerimid 8292 N75, which is suppled as a 75% by weight solution in methyl ethyl ketone (MEK), was obtained from Vantico, Inc./Huntsman Advanced Materials (Basel, Switzerland). The polyimide resin was then diluted to 25% by weight solution with MEK for the imbibing step. The ePTFE material was first completely wetted by MEK, then the material was soaked in polyimide solution for 1 hour. The majority of the MEK was then evaporated by air drying the sample. Further resin imbibing was conducted by brushing the polyimide solution onto the sample 3-4 times with a foam brush. The residual MEK was then removed from the sample by heating at 50° C. for 1 hour. The polyimide content of the imbibed material, or “prepreg,” was about 55% by weight (67.4 volume percent). The prepreg was then bonded to a 6 inch by 6 inch by 0.0625 inch thick stainless steel plate on a Carver press. The bonding was carried out for a 1 hour dwell at 250° C. and 300 psi. The bonded composite was then heated for about 1 hour at 225° C. The resulting sample was then tested for wear resistance, and results are reported in Table 1.

### Example 9

An ePTFE membrane manufactured by Sumitomo Electric Fine Polymer, Inc. Company (Part No. WP-500-100, Osaka, Japan). The membrane exhibited a columnar nodal microstructure as shown in FIG. 9 and had the following properties: Thickness=0.0041 inch, density=0.49 g/cc, pore size=5.0 microns, and IPA bubble point of 3.7 psi.

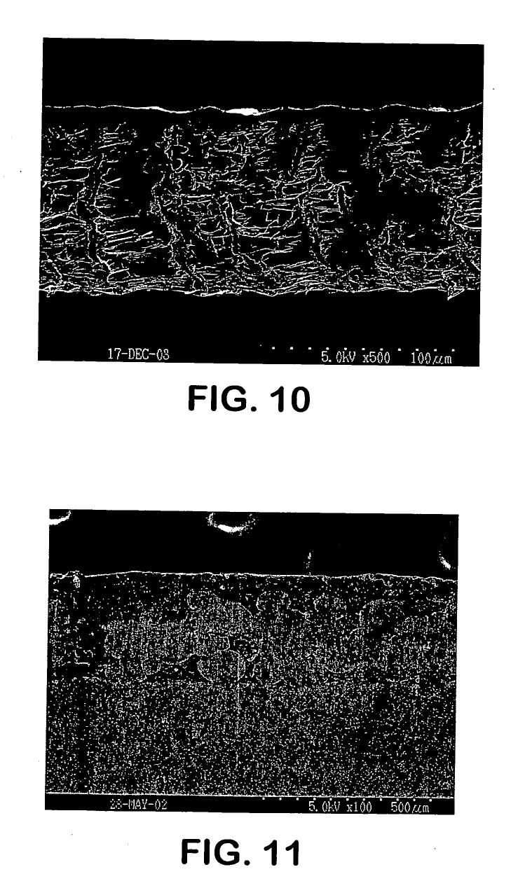

This membrane sample was imbibed using the same technique and epoxy described in Example 1 to an epoxy level of 68 wt % (80 volume percent of solids). FIG. 10 shows the cross section of the structure of FIG. 9 (unimbibed) after imbibing and curing. A 5 inch diameter disc was then bonded to a 6 inch by 6 inch piece of carbon steel as described in Example 1 and tested for 24 hour wear resistance. Results are reported in Table 1

TABLE 1
Wear Resistance of Imbibed ePTFE Examples

| Example | Weight % | Volume % | 24 hr. Wear |
|---|---|---|---|
| # | Epoxy | epoxy (solids) | (depth in microns) |
| 1 | 30 | 44 | 4 |
| | | | (6 day - 12.8) |
| 2 | 15 | 24.4 | 26.5 |
| 3 | 30 | 44 | 4.6 |
| 4 | 44 | 59 | 5.3 |
| 5 | 61 | 74.1 | 2.5 |
| 6 | 13.5 | 22.3 | 100 |
| 7 | 22 | 34 | 14.4 |
| 8 | 55 | 67.4 | 6 |
| 9 | 68 | (80) | 34.8 |

### Comparative Examples

### Comparative Example 1

### GARLOCK DU™ Bearing Material

A 6 inch by 6 inch sample of Garlock DU™ bearing material was obtained from the Glacier Garlock Bearings Company (Heilbronn, Germany). The sample was tested for wear resistance as previously described, and results are reported in Table 2. FIG. 9 is a photomicrograph taken at 100× magnification showing in cross-section the microstructure of the DU™ Bearing Material.

For comparative evaluation, the DU™ bearing material was also tested for coefficient of friction using the Coefficient of Friction Test, described earlier, with the same test conditions identified in Example 1. The graph shown in FIG. 13 shows the COF as a function of the Number of laps. The mean COF was 0.149.

### Comparative Example 2

### RULON® LR Bearing Material

A 4 inch by 6 inch sample of RULON® LR bearing material, made by Saint-Gobain Performance Plastics (Taunton, Mass.) was obtained from Tri Star Plastic Corporation (Massachusetts). The sample of RULON® LR bearing material was bonded to a 6 inch by 6 inch by 0.0625 inch thick piece of carbon steel using 3M VHB™ pressure sensitive adhesive (St. Paul, Minn.). The sample was then tested for wear as in the other examples, and results are reported in Table 2. FIG. 10 is a photomicrograph taken at 100× showing in cross-section the microstructure of the RULON® LR Bearing Material.

### Comparative Example 3

### Skived PTFE

A 6 inch wide by 6 inch long sample of full density skived PTFE film was obtained from the McMaster Carr catalog (Part number 8569K12, 2 mil thick). The sample was etched on one side and bonded to a 6 inch by 6 inch by 0.0625 inch thick piece of carbon steel using 3M VHB™ pressure sensitive adhesive (Minnesota). This sample was also tested for wear resistance, and the results are reported in Table 2. FIG. 13 is a photomicrograph taken at 100× showing in cross-section the microstructure of the skived PTFE bearing material.

### Comparative Example 4

### NORGLIDE® PRO 1.0 T Bearing Material

A sample of NORGLIDE® PRO 1.0 T bearing material was obtained from St.-Gobain Performance Plastics (Taunton, Mass.). This sample was tested, as received, for wear resistance, since it is already bonded to a metal substrate, and results are reported in Table 2. FIG. 12 is a photomicrograph taken at 50× showing in cross-section the microstructure of the NORGLIDE® PRO 1.0 T bearing material.

TABLE 2
Wear Resistance of Comparative Examples

| | | | 24 hr. Wear |
|---|---|---|---|
| Comparative | Material | | (depth in |
| Example # | Identification | Part # | microns) |
| 1 | GARLOCK | DU | 19.3 |
| 2 | RULON | LR | 53.5 |
| 3 | Skived ptfe | N/a | 376.3 |
| 4 | NORGLIDE | Pro 1.0 T | 28.6 |

1. An article comprising:
a porous expanded PTFE material having a microstructure defined by nodes interconnected by fibrils wherein the nodes are aligned to form one or more columns in the thickness direction of the material, and
at least one polymer resin selected from the group consisting of thermoset resins and thermoplastic resins distributed within the pores of the expanded PTFE.

2. The article of claim 1, wherein said one or more columns comprises a plurality of nodes.

3. The article of claim 1, wherein said one or more columns comprises a single node.

4. The article of claim 1, wherein said at least one polymer resin comprises an epoxy.

5. The article of claim 1, wherein said at least one polymer resin comprises a polyimide.

6. The article of claim 1, wherein said expanded PTFE comprises two or more layers of expanded PTFE.

7. The article of claim 1, wherein said expanded PTFE further includes at least one filler.

8. The article of claim 1, in the form of a sheet.

9. The article of claim 1, in the form of a tube.

10. The article of claim 1, wherein said article further comprises a pressure sensitive adhesive bonded to said article.

11. The article of claim 1, further comprising at least one substrate bonded to said article.

12. The article of claim 11, wherein said at least one substrate comprises at least one material selected from the group consisting of metal and epoxy.

13. A bearing material comprising:
a porous expanded PTFE material having a microstructure defined by nodes interconnected by fibrils wherein the nodes are aligned to form one or more columns in the thickness direction of the material, and
at least one wear resistant polymer resin distributed within the pores of the expanded PTFE.

14. The bearing material of claim 13, wherein said one or more columns comprises a plurality of nodes.

15. The bearing material of claim 13, wherein said one or more columns comprises a single node.

16. The bearing material of claim 13, wherein said at least one polymer resin comprises an epoxy.

17. The bearing material of claim 13, wherein said at least one polymer resin comprises a polyimide.

18. The bearing material of claim 13, wherein said expanded PTFE structure comprises two or more layers of expanded PTFE.

19. The bearing material of claim 13, wherein said expanded PTFE further includes at least one filler.

20. The bearing material of claim 13, in the form of a sheet.

21. The bearing material of claim 13, in the form of a tube.

22. The bearing material of claim 13, in the form of a wear-resistant surface.

23. The bearing material of claim 13, in the form of a bearing.

24. The bearing material of claim 13, in the form of a washer.

25. The bearing material of claim 13, in the form of a clutch.

26. The bearing material of claim 13, in the form of a tensioning device.

27. The bearing material of claim 13, wherein said article further comprises a pressure sensitive adhesive bonded to said bearing material.

28. The bearing material of claim 13, further comprising at least one substrate bonded to said bearing material.

29. The bearing material of claim 28, wherein said at least one substrate comprises at least one material selected from the group consisting of metal and epoxy.

30. An article comprising:
a composite comprising a porous expanded PTFE material having a microstructure defined by nodes interconnected by fibrils wherein the nodes are aligned to form one or more columns in the thickness direction of the material, and
at least one polymer resin selected from the group consisting of thermoset resins and thermoplastic resins distributed within the pores of the expanded PTFE; and
a substrate bonded to said composite.

31. The article of claim 30, wherein said one or more columns comprises a plurality of nodes.

32. The article of claim 30, wherein said one or more columns comprises a single node.

33. The article of claim 30, in the form of a wear-resistant surface.

34. The article of claim 30, in the form of a bearing.

35. The article of claim 30, in the form of a washer.

36. The article of claim 30, in the form of a clutch.

37. The article of claim 30, in the form of a tensioning device.

38. The article of claim 30, wherein said at least one polymer resin comprises an epoxy.

39. The article of claim 30, wherein said at least one polymer resin comprises a polyimide.

40. The article of claim 30, wherein said expanded PTFE comprises two or more layers of expanded PTFE.

41. The article of claim 30, wherein said expanded PTFE further includes at least one filler.

42. The article of claim 30, in the form of a sheet.

43. The article of claim 30, in the form of a tube.

44. A method of forming a bearing material comprising:
providing a porous expanded PTFE material having a microstructure defined by nodes interconnected by fibrils wherein the nodes are aligned to form one or more columns in the thickness direction of the material;
imbibing in at least a portion of the porosity at least one polymer resin selected from the group consisting of thermosetting resins and thermoplastic resins; and
curing said at least one polymer resin.

45. The method of claim 44, further comprising bonding said imbibed expanded PTFE material to a substrate.
